(19) United States
(12) Patent Application Publication
(10) Pub. No.: US 2026/0233143 A1
(43) Pub. Date: Aug. 13, 2026

(54) Suction device

(71) Applicant: Producteers International GmbH, Schorndorf (DE)

(72) Inventor: Holger Krogsgaard, Silkeborg (DK)

(73) Assignee: Producteers International GmbH, Schorndorf (DE)

(21) Appl. No.: 19/537,048

(22) Filed: Feb. 11, 2026

(30) Foreign Application Priority Data
Feb. 12, 2025 (DE) 10 2025 000 593.8

(51) Int. Cl. B01D 46/24; A47L 9/16; B01D 45/16

(52) U.S. Cl. CPC B01D 46/2411; A47L 9/1691; B01D 45/16

(57) ABSTRACT

A suction device has a collection container, a drive unit with a suction motor, upstream of which a filter unit is connected, and a pre-separator, which is connected upstream of the filter unit. The suction motor and the filter unit are at least partially arranged on that side of the pre-separator that faces away from the collection container and are situated next to each other. Irrespective of the position of the filter unit and the suction motor, the suction device can also be designed such that at least one deflector is arranged in the falling path of the dust/dirt particles that fall from the filter unit during the cleaning process.

### CROSS-REFERENCE TO RELATED APPLICATION

This application claims the benefit of German Patent Application DE 10 2025 000 593.8, filed on Feb. 12, 2025, the content of which is incorporated in its entirety.

### TECHNICAL FIELD

The invention relates to a suction device, such as a vacuum.

### BACKGROUND

Suction devices, or vacuums, are known in which a pre-separator is arranged as an independent unit between a collection container for extracted dirt and a drive unit. Such a suction device takes up a large amount of space and is also unwieldy.

### SUMMARY

The disclosure is based on the object of designing a suction device to be compact, easy to handle and to have good suction.

This object is solved by a suction device in which a filter unit, a suction motor, and a pre-separator are provided in an area above a collection container. This results in a very compact design of the suction device. In particular, it does not consist of individual separate structural units interconnected by hoses. As a result, the suction device can be handled particularly easily. A factor that contributes in particular to the suction device having a compact design is that the filter unit and the suction motor are at least partially arranged on that side of the pre-separator that faces away from the collection container, as well as next to each other. As a result, the suction device has only a low height, which significantly contributes to making the suction device easier to handle. In addition, due to this arrangement, the flow paths between the pre-separator, the filter unit and the suction motor are short.

It is particularly advantageous when the filter unit and the pre-separator are mutually aligned. This contributes to giving the suction device a compact design.

So that the suction device has optimum suction, the filter unit is advantageously provided with a base body on the outer side of which filter lamellae are arranged. Suspended from said filter lamellae are the dust/dirt particles still present in the air that could not be removed beforehand by the pre-separator.

In one advantageous embodiment, the filter lamellae run in the axial direction of the filter unit. As a result, there is a large filter surface area for reliably removing the dust/dirt particles from the air flow.

To ensure effective filtering of the dust/dirt particles from the air flow over a long period of use, the filter unit is advantageously connected to a cleaning device for removing the dust/dirt particles adhering to the filter lamellae. If the filter lamellae are so clogged with dust/dirt particles that effective filtering is no longer possible, the cleaning device is actuated, which ensures that the dust/dirt particles are removed from the filter lamellae.

In one preferred embodiment, the cleaning device is a vibrating device. This causes the filter unit to vibrate so much that the dust/dirt particles adhering to the filter lamellae fall downwards.

In one preferred embodiment, the vibrating device is provided with an electromagnet which interacts with at least one metal part connected to the filter unit. On actuation of the electromagnet, this metal part causes the filter unit to vibrate so much that the dust/dirt particles adhering to the filter lamellae fall off.

So that the user of the suction device can easily remove the filter unit, the filter unit is provided with at least one handle element.

Preferably, the handle element is formed by a cover which can be positioned in a cover of a housing of the drive unit. In this case, the cover may be made to lie flush with the housing cover, so that it does not impair the functionality of the suction device.

Particularly advantageously, the pre-separator is a cyclone separator. The latter can be used in the first filtering stage to optimally remove the dust/dirt particles present in the air flow.

Advantageously, the cyclone separator is provided on a baseplate, via which the cyclone separator can be connected to the collection container.

To ensure reliable cleaning of the filter lamellae, the spaces between adjacent filter lamellae are advantageously open towards the collection container. This structurally very simple design ensures that the dust/dirt particles adhering to the filter lamellae reliably fall downwards towards the collection container during the cleaning process.

In a further embodiment, at least one deflector is arranged in the falling path of the dust/dirt particles that fall from the filter unit during the cleaning process. This ensures that the dust/dirt particles are reliably guided to the collection container. The position of the suction motor is not important in this case.

A particularly simple and yet effective design is achieved when the deflector is a cone. The dust/dirt particles are reliably guided to the collection container along the lateral surface of said cone.

It is particularly advantageous when the filter unit is arranged on the deflector.

The dust/dirt particles are guided effectively when the cone angle is greater than approximately 25°.

The cyclone separator is advantageously partially closed off from the collection container.

In this case it is particularly advantageous when the filter lamellae are substantially situated in the area outside the area of the cyclone separator which is closed off from the collection container.

### BRIEF DESCRIPTION OF THE DRAWINGS

The invention is explained in more detail on the basis of two exemplary embodiments shown in the drawings, which show:

FIG. 1: a perspective illustration of a suction device;

FIG. 2: another perspective illustration of the suction device;

FIG. 3: a plan view of the suction device;

FIG. 4: an enlarged illustration of a section along the line A-A in FIG. 3;

FIG. 5: an illustration corresponding to FIG. 4 of the suction device with a filter unit clogged with dirt particles;

FIG. 6: an illustration according to FIG. 5 of the suction device while the filter unit is being cleaned;

FIG. 7: the suction device in a side view;

FIG. 8: an enlarged illustration of a section along the line B-B in FIG. 7;

FIG. 9: a perspective illustration of the filter unit of the suction device;

FIG. 10: a perspective illustration and bottom view of an upper part of the suction device;

FIG. 11: a cyclone separator and the filter unit of the suction device in an axial view;

FIG. 12: a perspective illustration of the suction device without housing of a drive unit;

FIG. 13: an illustration similar to FIG. 12 of the suction device with cover of the filter unit removed;

FIG. 14: an illustration corresponding to FIG. 13 of the suction device without cyclone separator;

FIG. 15: a section through a second embodiment of a suction device.

### DETAILED DESCRIPTION

The suction device has a collection container 1 for the dust/dirt particles picked up during suction. The collection container 1 sits on an advantageously movable frame 2. Impellers 3, 4 are provided for this purpose; the impellers 3, for example, have smaller diameters than the impellers 4. The impellers 3 are in each case mounted on a U-shaped bracket 5 so as to rotate about a horizontal axis, said bracket being held on the frame 2 so as to rotate about a vertical axis.

The impellers 4 are only rotatable about a horizontal axis and not a vertical axis.

A drive unit 6 having a housing 7, which is releasably attached to the collection container 1, is located on the collection container 1. The releasable attachment of the housing 7 to the collection container 1 can be achieved by any suitable means, for example by quick-release fasteners 8, which have a known design and are advantageously pivotably mounted on the outer side of the housing 7.

A port 9 to which a suction hose can be connected protrudes from the housing.

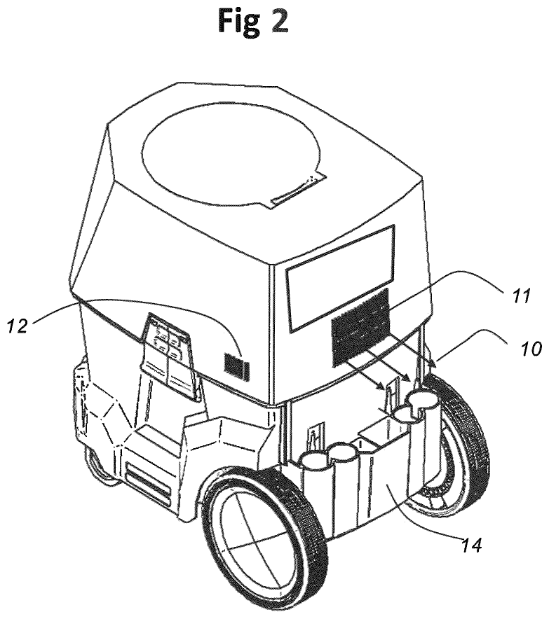

Also provided on the housing 7 is an air outlet 10 (FIG. 2), through which the sucked-in air can exit the suction device following the filtering process. The air outlet 10 can be covered by a grille 11, a filter element and the like.

Also located on the housing 7 is an air inlet 12 (FIG. 2), through which the cooling air for cooling a motor housed in the housing 7 can be sucked. A grille, a filter element and the like can be provided on the air inlet 12, in order to filter the outside air sucked in for cooling the motor before it enters the housing 7.

The cooling air sucked in via the air inlet 12 exits again via an outlet 13 provided on the housing 7.

Advantageously located on the rear side of the collection container 1 in the area between the two impellers 4 are repositories 14 for accessories for the suction device. By way of example, the repositories 14 are plug-in receptacles, which extend, by way of example, vertically and into which the accessories can be plugged from above. Since the repositories 14 are located in the area between the impellers 4 which project beyond the housing 7 (FIG. 2), the repositories 14 can be provided in a space-saving manner on the outer side of the collection container 1.

The suction port 9 in the form of a tube port leads tangentially into a pre-separator in the form of a cyclone separator 15 (FIG. 8), which is housed in the housing 7. The sucked-in air flow flows through said housing in a known manner, with the coarse dust/dirt particles in the sucked-in air flow being removed from the air flow. These dust/dirt particles fall downwards into the collection container 1.

Flow arrows have been drawn in FIG. 8 to illustrate the flow path of the air within the cyclone separator 15.

The cyclone separator 15 is secured in the housing 7 by a baseplate 16. The baseplate 16 is provided on the end of the housing 7 facing the collection container 1 and is connected to the housing 7 in a suitable manner.

The baseplate 16 and the cyclone separator 15 are advantageously formed integrally with each other. The cyclone separator 15 extends out from the baseplate 16 into the interior of the housing 7 (FIG. 4).

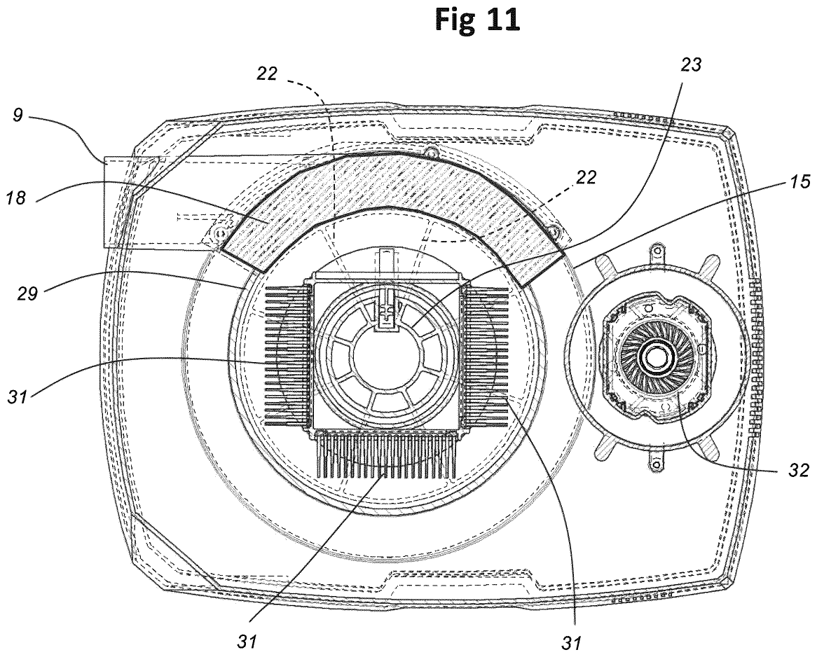

The cyclone separator 15 has a narrow annular baffle plate 17 (FIGS. 8 and 10). FIG. 11 shows an area 18 of the baffle plate 17—marked by hatched lines-which is closed off from the collection container 1.

This area 18 extends, by way of example, over an angle range between approximately 90° and 180°.

The baffle plate 17 is advantageously formed integrally with the baseplate 16.

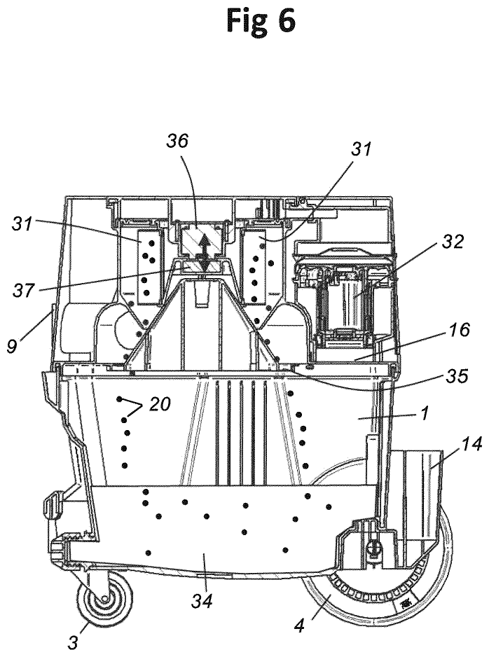

The cyclone separator 15, as viewed in the axial direction of same, surrounds a conical wall, which forms a deflector 19 for dust/dirt particles when the latter fall downwards—as will be described hereinafter—during a cleaning process of a filter unit. The deflector 19 then ensures that these dust/dirt particles 20 (FIG. 6) are led downwards into the collection container 1.

The deflector 19 is advantageously formed integrally with the baffle plate 17 and tapers from the baffle plate 17 upwards towards a cover 21 of the housing 7.

The deflector 19 advantageously protrudes above the cyclone separator 15, so that the dust/dirt particles 20 reliably reach the deflector 19 and from there are led downwards to the collection container 1.

As is apparent from FIGS. 8 and 10, the deflector 19 is supported on the inside by radially extending narrow carriers 22, which extend outwards from a central tube 23. The carriers 22 are mutually spaced apart and are advantageously formed integrally with both the tube 23 and the deflector 19. In principle, it is also possible to design the carriers 22, the central tube 23 and the deflector 19 as separate parts, which are connected to each other in a suitable manner.

It is also possible to dispense with the carriers 22 and the tube 23 when the deflector 19 is sufficiently stable.

At the end averted from the baseplate 16, the deflector 19 is closed by an end wall 24, which is advantageously flat and advantageously extends perpendicular to the axis of the deflector 19.

A cleaning device 25 for cleaning a filter unit 26 is arranged in the area above the deflector 19. The cleaning device 25 can have a known design. It is used to remove dust/dirt particles 20 retained in the filter unit 26 in a cleaning process if said particles have clogged the filter unit 26 or filter lamellae 31 located thereon so much that it is no longer possible to effectively clean the air.

Since the cleaning device 25 for such suction devices is known per se, it is not explained in any more detail. The cleaning device 25 can be designed, for example, as a vibrating apparatus, which uses a vibrating motion to make the filter unit 26 vibrate to such an extent that the adhering dust/dirt particles 20 fall off.

Advantageously, the axes of the deflector 19 and of the cleaning device 25 and of the filter unit 26 are mutually aligned. This gives the drive unit 6 a compact design, in the housing 7 of which the cyclone separator 15, the deflector 19, the cleaning device 25 and the filter unit 26 are housed.

Since the cleaning device 25 protrudes at least partially into the filter unit 26, this contributes to a particularly compact design of the drive unit 6.

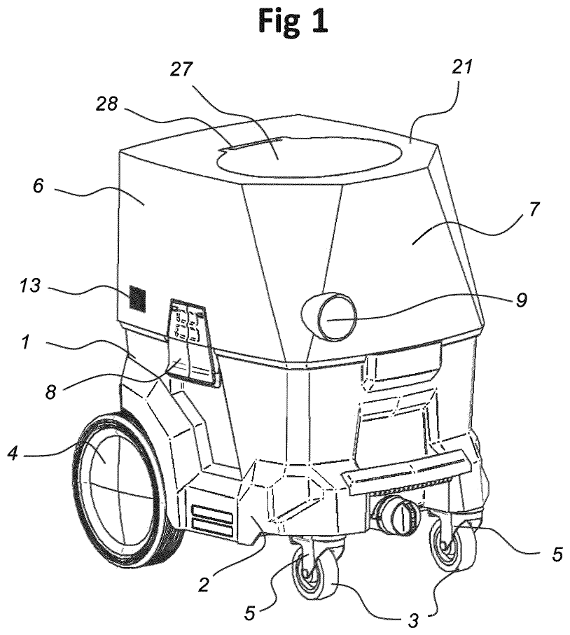

So that the filter unit 26 can easily be removed from the drive unit 6, a filter cover 27 that is pivotable about an axis 28 (FIG. 1) is provided in the cover 21 of the housing 7. The pivot axis 28 lies in the cover 21 of the housing 7 and makes it possible to pivot the filter cover 27 upwards in order to remove the filter unit 26.

In the closed position shown in FIGS. 1 and 2, the filter cover 27 lies flush in the housing cover 21. It is advantageous when the filter cover 27 is latched onto the housing 7 in the shown closed position.

It is advantageous when the filter cover 27 is spring-loaded into its open position. Then, following release of the latching connection, the filter cover 27 can easily be pivoted up into a release position.

The filter cover 27 can also be releasably connected to the housing cover 21, so that it can be released fully from the housing cover 21 so as to insert the filter unit 26 into the drive unit 6 or remove it therefrom.

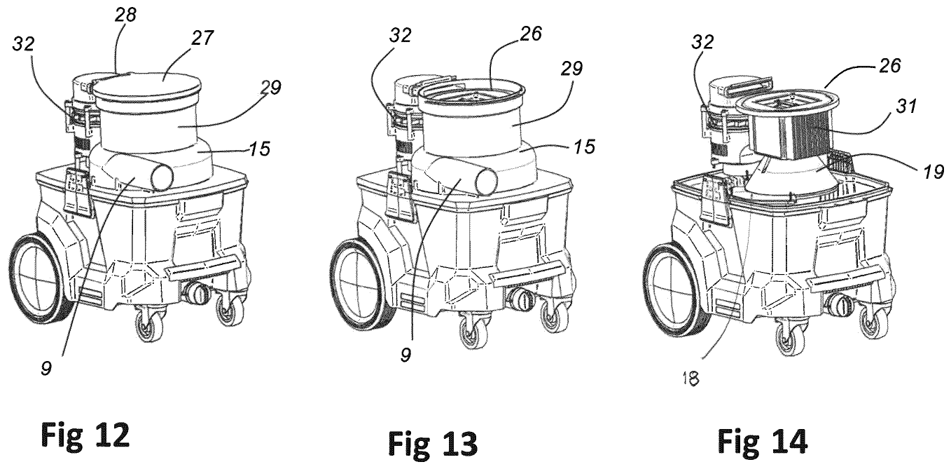

The filter unit 26, which surrounds the cleaning device 25, is located in an advantageously cylindrical housing 29 (FIGS. 12 and 13). The housing 29 protrudes axially beyond the filter unit 26 (FIG. 13). The filter cover 27 advantageously rests on the upper edge of the housing 29 (FIG. 12).

The housing 29 is supported on the cyclone separator 15, so that said housing is held axially in the installation position by the cyclone separator 15 and the filter cover 27.

The filter unit 26 has a central base body 30, which in the exemplary embodiment has an angular outline, preferably a square outline. As FIG. 11 shows, provided on three outer sides of the base body 30 are the filter lamellae 31, which extend in the axial direction of the base body 30 and advantageously have the same axial length as these sides of the base body 30. The filter lamellae 31 are provided over the entire width of the outer sides of the base body 30.

The filter lamellae 31 extend in the axial direction of the filter unit 26 or the base body 30 thereof. The filter lamellae 31 consist of any suitable filter material that is capable of reliably filtering the dust/dirt particles 20 still present in the air flow that exits the cyclone separator 15.

As is apparent from FIG. 11, no filter lamellae are provided on the outer side of the base body 30 that faces towards the area 18.

A suction motor 32 which is used to generate the suction air for the suctioning process is located within the housing 7 of the drive unit 6 in the area next to the cyclone separator 15 and the filter unit 26. The suction motor 32 is suitably positioned in the housing 7 and preferably held on the baseplate 16.

As FIG. 11 shows, the suction port 9 and the suction motor 32 are situated on different sides of the cyclone separator 15. The suction motor 32 is situated with a spacing below the housing cover 21. A flow chamber 33 for the sucked-in air is thereby formed between the housing cover 21 and the suction motor 32 (FIG. 4).

When the suction motor 32 is switched on, the medium moved with the dust/dirt particles 20 is sucked into the port 9. Connected to the latter in a known manner is a suction hose which has a tool, such as a suction brush. The sucked-in medium together with the dust/dirt particles 20 reaches the cyclone separator 15 via the port. The flow arrows for the sucked-in air are shown in FIG. 4.

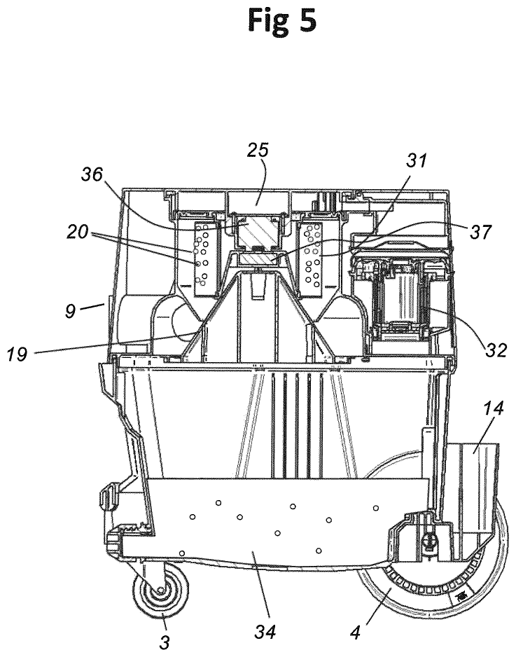

In the cyclone separator 15, the coarse dust/dirt particles are removed from the dirt stream in a known manner by a cyclone effect. These particles fall downwards into the collection container 1. FIGS. 5 and 6 show, by way of example, the dirt 34 that has gathered in collection container 1.

The suction air separated from the dust/dirt particles passes from the cyclone separator 15 to the filter unit 26, as shown by the flow arrows in FIG. 4. The air still contains fine dust/dirt particles 20, which remain suspended from the filter lamellae 31 of the filter unit 26.

The thus cleaned suction air flows through the suction motor 32 and exits the suction device from the air outlet 10.

The dust/dirt particles are retained on the filter lamellae 31. This is shown in FIG. 5 by way of example. Over time, the filter lamellae 31 become so clogged by the deposited dust/dirt particles 20 that only a very limited cleaning effect is possible. In this case, a cleaning process begins, with the aid of which the filter lamellae 31 are freed of the dust/dirt particles 20 again.

The filtering/cleaning process can be started automatically, but also initiated by the user of the suction device. In the case of the advantageously automatic cleaning, the suction pressure in front of and behind the filter lamellae 31 is detected by corresponding sensors. As the filter lamellae 31 become increasingly clogged, the pressure difference between the suction flow in front of and behind the filter lamellae 31 increases. As soon as a specified threshold value is reached, the cleaning process is automatically started.

The cleaning process can also be initiated, for example, time-dependently or as a function of the number of suction processes started.

During the cleaning process, the dust/dirt particles 20 are released from the filter lamellae 31 and then fall downwards into the collection container 1 (FIG. 6). Since the filter lamellae 31 are arranged upright, the dust/dirt particles 20 can reliably pass downwards into the collection container 1. The dust/dirt particles 20 falling from the filter lamellae 31 reach the deflector 19, by means of which the dust/dirt particles 20 are reliably led downwards into the collection container 1.

The baseplate 16 is provided with at least one corresponding passage opening 35, through which the dust/dirt particles 20 can pass downwards into the collection container 1.

By way of example, the cleaning device 25 has an electromagnet 36, which interacts with a metal part 37 coupled to the base body 30 of the filter unit 26. By actuating the electromagnet 36 of the cleaning device 25, the metal part 37 is moved back and forth in the vertical direction (see double arrow in FIG. 6), whereby the filter unit 26 correspondingly performs back and forth movements. These vibrating movements cause the dust/dirt particles 20 adhering to the filter lamellae 31 to become detached, so that they fall downwards and are guided via the deflector 19 to the collection container 1.

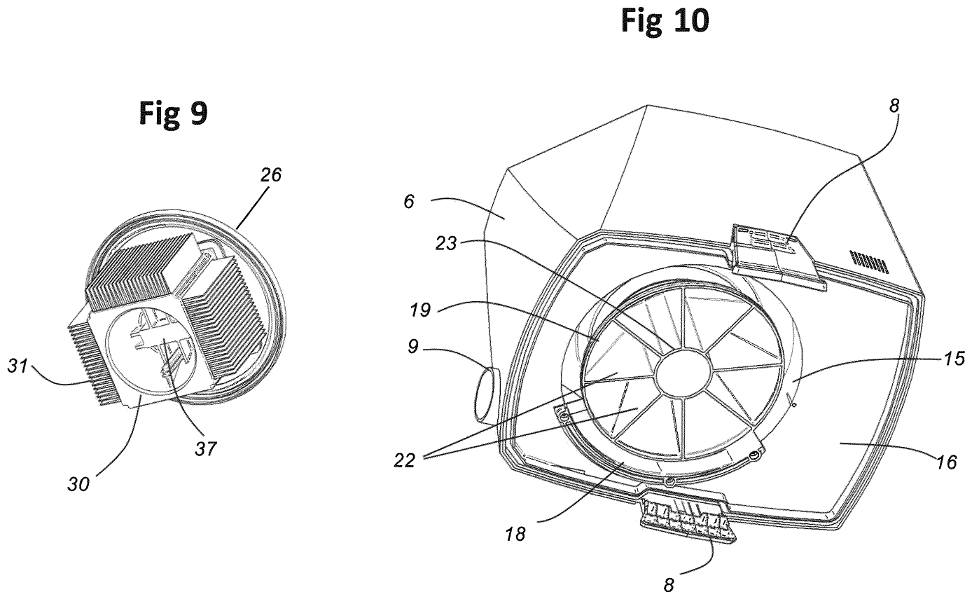

FIG. 9 shows an exemplary design of the filter unit 26. The base body 30 thereof is designed as a hollow body in which the metal part 37 is held. The cavity of the base body 30 can be closed by a preferably removable cover.

The collection container 1 can easily be emptied by opening the quick-release fastener 8 and removing the drive unit 6 from the collection container 1. The dirt 34 that has accumulated in the collection container 1 can then be easily discarded. The quick-release fasteners 8 allow the drive unit 6 to likewise be easily positioned on the collection container 1.

The described suction device is characterised by a very compact structural design. This is due, in particular, to the fact that the suction motor 32 and
the filter unit 26 are arranged inside the drive unit 6, with the suction motor 32 being provided in the area next to the cyclone separator 15 and the filter unit 26.

Despite the compact design, the suction device is characterised in that the dust/dirt particles in the extracted dirty air are reliably caught, so that cleaned air exits the air outlet 10.

The deflector 19 contributes particularly to this in that the dust/dirt particles 20 falling from the filter lamellae 31 during the cleaning process are reliably led downwards into the collection container 1. In order to optimise this deflecting function of the deflector 19, the cone angle is advantageously greater than 25°. The deflector 19 is located largely within the cyclone separator 15 which surrounds it. In this case, the deflector 19 is substantially located in the falling area of the dust/dirt particles 20 that fall from the filter lamellae 31 during the cleaning process.

Since interspaces, which are open towards the bottom towards the deflector 19 or the cyclone separator 15, are formed between the filter lamellae 31, the dust/dirt particles that fall during the cleaning process can reliably fall downwards from the area between the filter lamellae 31.

The filter lamellae 31, as apparent from FIG. 1, are only provided in that area which is situated outside the closed area 18 of the cyclone separator 15.

The described cleaning effect due to a vibrating motion of the filter unit 26 is only to be understood as an example. Other ways of cleaning the filter lamellae 31 are also available. For example, it is also possible to use compressed air for the cleaning process, which flows outwards from the inside of the base body 30, thereby freeing the filter lamellae 31 located on the outer side of the base body 30 of the adhering dust/dirt particles 20.

The deflector 19 is preferably designed as a conical body, but can also have any other suitable shape. What is important is that the dust/dirt particles 20 that fall from the filter lamellae 31 during the cleaning process are reliably led downwards into the collection container 1.

In a deviation from the exemplary embodiment shown, the suction device can also be designed such that, for example, the suction motor 32 is situated above the filter unit 26. It is merely important here that the filter unit 26 is situated in the area above the deflector 19, so that the dust/dirt particles 20 are reliably led into the collection container 1. The position of the suction motor 32 in the housing 7 of the drive unit 6 can be different to that shown in this case.

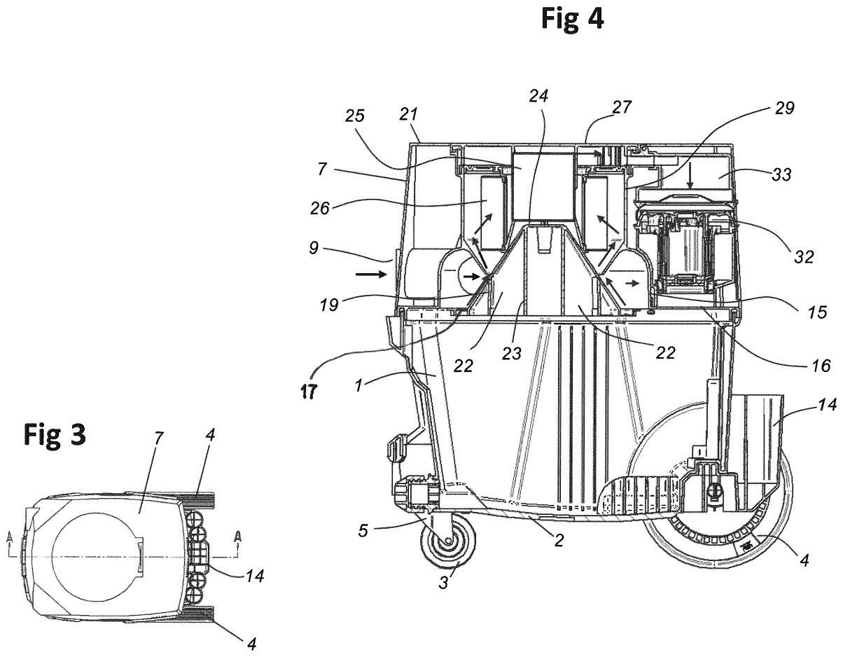

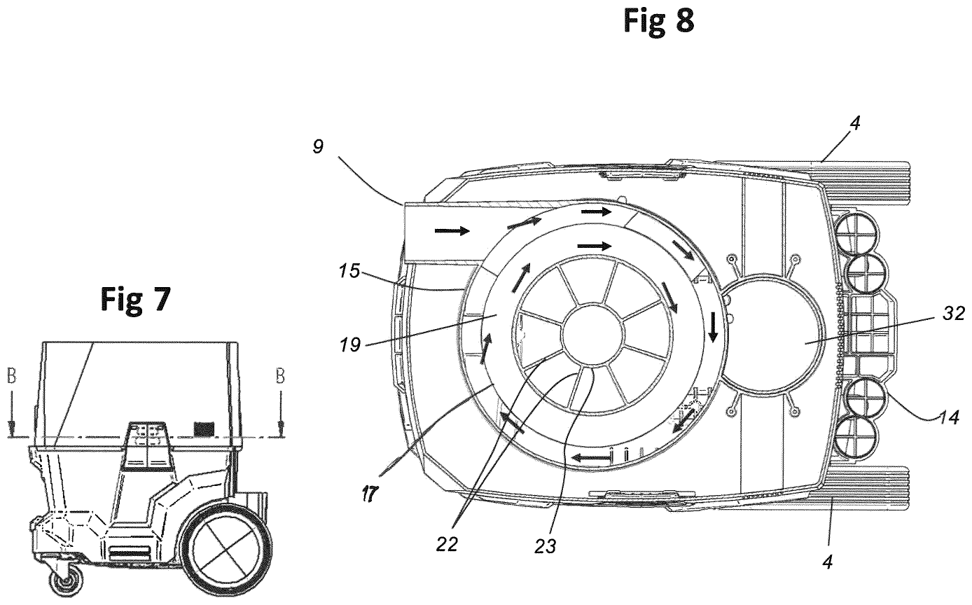

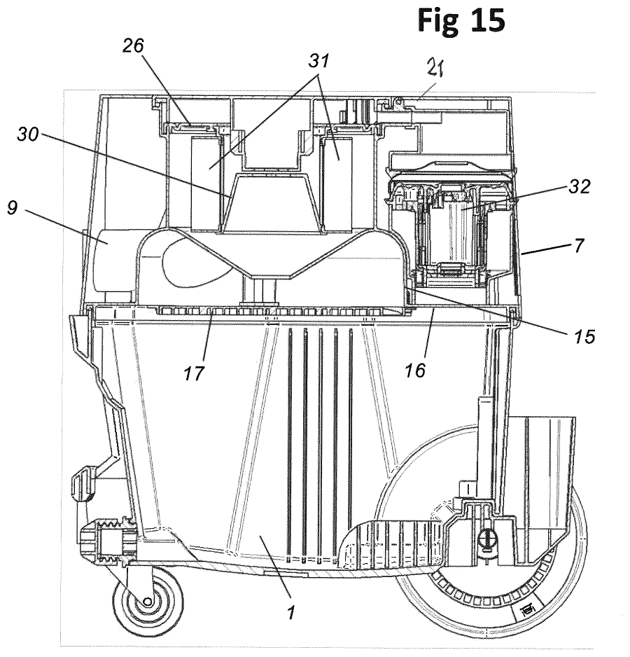

The suction device according to FIG. 15 has a similar design to the above-described exemplary embodiment. The principal difference is that there is no deflector for deflecting the dust/dirt particles that become detached from the filter lamellae 31 during the cleaning process. As in the preceding exemplary embodiment, the cyclone separator 15 is releasably connected to the collection container 1 via the baseplate 16. The port 9 is connected tangentially to the cyclone separator 15 and, in accordance with the preceding embodiment, protrudes beyond the housing 7, so that a suction hose can be conveniently connected up. Reference is made to the description given for the embodiment in accordance with FIG. 1 to 14.

The filter unit 26 with the vertically arranged filter lamellae 31 is located in the area above the cyclone separator 15. The exact design has been described in detail on the basis of the preceding embodiment and so reference is made to that description.

Unlike in the preceding embodiment, a cleaning device is not provided. If the filter lamellae 31 are clogged by the dust/dirt particles or the filtering power diminishes, the user can lift the filter unit 26 out of the housing 7 and clean the filter lamellae 31. The filter unit 26 is then reinserted in the housing 7.

The cyclone separator 15 is covered towards the collection container 1 by the baffle plate 17, which, unlike in the preceding exemplary embodiment, is flat. The baffle plate 17 increases the efficacy of the cyclone separator 15 in comparison to the preceding embodiment with the deflector 19. Should some of the dust/dirt particles 20 suspended from the filter lamellae 31 fall onto the baffle plate 17 when the filter unit 26 is being lifted out, then said particles are sucked up again during the next suctioning process and supplied to the filter unit 26.

Positioned in the area next to the filter unit 26 is the suction motor 32, which, in accordance with the preceding embodiment, is connected to the baseplate 16 or the cyclone separator 15 via a support 38.

The filter unit 26 and the suction motor 32 are situated, as in the preceding exemplary embodiment, next to each other substantially transverse to the axis of the cyclone separator 15. As a result, the suction device only has only a low overall height, meaning that it can have a very compact design.

The suction motor 32 can also have another position in the apparatus of the drive unit 6, however.

Advantageously, the cyclone separator 15, the filter unit 26 and the suction motor 32 form a structural unit, which can easily be inserted into the housing 7 of the drive unit 6.

The dirty air sucked in via the port 9 first passes through the cyclone separator 15, within which the coarse dirt particles are removed from the air flow in a known manner. The thus cleaned air flow then passes to the filter unit 26. The air flows through the filter lamellae 31 in the base body 30. The filter lamellae 31 capture any fine dust/dirt particles 20 still present. The thus cleaned air then passes from the filter unit 26 to the suction motor 32, via which the cleaned air is led outwards via the air outlet 10.

Insofar as the two embodiments have the same structure or the same design form, reference is expressly made to the description of the preceding embodiment in accordance with FIG. 1 to 14, which also applies to the embodiment according to FIG. 15.

What is claimed is:

1. A suction device, comprising:
a collection container (1);
a drive unit (6) including a suction motor (32);
a filter unit (26) disposed upstream of the drive unit (6); and
a pre-separator (15) disposed upstream of the filter unit (26),
wherein the filter unit (26) and the suction motor (32) are arranged at least partially on a side of the pre-separator (15) facing away from the collection container (1), and
wherein the filter unit (26) and the suction motor (32) are arranged adjacent to each other.

2. The suction device according to claim 1,
wherein the filter unit (26) and the pre-separator (15) are coaxially aligned.

3. The suction device according to claim 1,
wherein the filter unit (26) has a base body (30) and filter lamellae (31) arranged on an outer side of the base body (30).

4. The suction device according to claim 3,
wherein the filter lamellae (31) run in an axial direction of the filter unit (26).

5. The suction device according to claim 4,
wherein the filter unit (26) is connected to a cleaning device (25) for removing dust or dirt particles (20) adhering to the filter lamellae (31).

6. The suction device according to claim 5,
wherein the cleaning device (25) is a vibrating device.

7. The suction device according to claim 6,
wherein the vibrating device (25) includes an electromagnet (36), and
wherein the electromagnet (36) interacts with at least one metal part (37) fixedly connected to the filter unit (26).

8. The suction device according to claim 1,
wherein the filter unit (26) is provided with at least one handle element (27).

9. The suction device according to claim 8,
wherein the handle element (27) is a cover configured to be positioned in a further cover (21) of a housing (7) of the drive unit (6).

10. The suction device according to claim 1,
wherein the pre-separator (15) is a cyclone separator.

11. The suction device according to claim 10,
wherein the cyclone separator (15) is provided on a baseplate (16) that is configured to be connected to the collection container (1).

12. The suction device according to claim 3,
wherein spaces between adjacent filter lamellae (31) are open towards the collection container (1).

13. A suction device, comprising:
a collection container (1);
a drive unit (6) including a suction motor (32);
a filter unit (26) disposed upstream of the drive unit (6);
a pre-separator (15) disposed upstream of the filter unit (26); and
at least one deflector (19) arranged in a falling path of dust or dirt particles (20) that fall from the filter unit (26) during a cleaning process.

14. The suction device according to claim 13,
wherein the deflector (19) is a cone.

15. The suction device according to claim 14,
wherein a cone angle of the cone is greater than 25°.

16. The suction device according to claim 13,
wherein the deflector (19) is arranged below the filter unit (26).

17. The suction device according to claim 13,
wherein the filter unit (26) is attached to the deflector (19).

18. The suction device according to claim 13,
wherein the pre-separator (15) is a cyclone separator, and
wherein the cyclone separator (15) is at least partially closed off from the collection container.

19. The suction device according to claim 18,
wherein the filter unit (26) has a base body (30) and filter lamellae (31) arranged on an outer side of the base body (30), and
wherein the filter lamellae (31) are substantially situated outside of the cyclone separator (15).
